(19) United States
(12) Patent Application Publication
(10) Pub. No.: US 2013/0286010 A1
(43) Pub. Date: Oct. 31, 2013

(54) Method, Apparatus and Computer Program Product for Three-Dimensional Stereo Display

(71) Applicant: Qifeng Yan, Espoo (FI)

(72) Inventor: Qifeng Yan, Espoo (FI)

(73) Assignee: NOKIA CORPORATION, Espoo (FI)

(21) Appl. No.: 13/979,454

(22) PCT Filed: Jan. 30, 2011
(86) PCT No.: PCT/CN11/70811

§ 371 Date: Jul. 12, 2013

(51) Int. Cl. H04N 13/00

(52) U.S. Cl. CPC H04N 13/0022
USPC 345/419; 348/46; 348/47

(57) ABSTRACT

Provided are a method, an apparatus and a computer program product for a three-dimensional stereo display. The method comprises capturing images of an object for the three-dimensional stereo display, calculating a disparity level of the object by comparing the captured images, adjusting a disparity level of an identification element to be the same as that of the object, and displaying the identification element along with the object in a same depth in the three-dimensional stereo display. Due to being in the same depth of the display, the 3D image displayed in this manner is more natural, vivid and clear and it is easier for the objects in such 3D image to be identified. Thereby, a viewer would enjoy a better user experience in the 3D stereo display.

### FIELD OF THE INVENTION

Embodiments of the present invention generally relate to a three-dimensional (3D) stereo display. More particularly, embodiments of the present invention relate to a method, an apparatus, and a computer program product for presenting an image in a 3D stereo display.

### BACKGROUND OF THE INVENTION

With increasing advances of the display technology, the 3D image has become more and more popular nowadays due to its natural, vivid and highly-clear visual effect. People may view a wide variety of augmented reality or stereoscopic images through 3D-enabled devices. Generally, a 3D stereoscopic image is formed by combining images captured by two, or more cameras (e.g., including an infrared camera for an additional enhanced effect), wherein one cameras plays a role as a left eye of a human being while another one as a right eye.

To facilitate identifying a number of objects in a same 3D stereoscopic image, a plurality of identification elements (e.g., icons, tags or other 3D elements) may be utilized and each identification element may identify a single object by being attached or presented adjacent thereto. This may be convenient when the number of the objects is small and these objects are arranged with sufficient spacing such that the identification elements overlaid on the same 3D stereo image may be sufficiently separated from each other.

However, in a situation where some objects are narrowly arranged in a 3D stereo image, the above identification elements may be overlaid by each other and thus it may be difficult to distinguish which identification element may identify which object. For purpose of better understanding, FIG. 1 illustrates a similar situation as above-mentioned. As shown in the picture of FIG. 1, a number of automobiles are parked substantially in a line with each other. In the 3D stereo display which is totally different from what is saw in this two-dimensional (2D) picture, logos, such as BMW, Ford and etc, may be viewed by eyes of users as being overlaid by each other across a stop line. In this case, it is hard to determine the brand of each automobile because these logos are not displayed in a same depth as those automobiles in the 3D stereo display.

### SUMMARY OF THE INVENTION

In view of the foregoing problems in the existing 3D stereo display, there is a need in the art to provide a method, an apparatus and a computer program product for a 3D stereo display so that identification elements which may serve as identifying the objects in the 3D image may be automatically adjusted to be displayed in a same depth as their respective objects in the 3D stereo display.

One embodiment of the present invention provides a method. The method comprises capturing images of an object for a three-dimensional stereo display. The method also comprises calculating a disparity level of the object by comparing the captured images. Further, the method comprises adjusting a disparity level of an identification element to be the same as that of the object. In addition, the method comprises displaying the identification element along with the object in a same depth in the three-dimensional stereo display.

In one embodiment, the method may further comprise using an image capturing device which is incorporated into a mobile device and has two or more cameras to capture images for the three-dimensional stereo display.

In another embodiment, the calculating the disparity level of the object further comprises calculating an offset distance between one or more corresponding reference points on an outline of the object in the two captured images.

In a further embodiment, the reference points have much shorter distance to an image capturing device which has captured the images than other points on the outline of the object.

In an additional embodiment, the calculating the disparity level of the object further comprises calculating offset distances between each of the reference points and then averaging the calculated offset distances.

In one embodiment, the calculating the disparity level of the object further comprises calculating offset distances between each of the reference points and then giving the reference points different weights to obtain respective disparity level of each reference point.

In a further embodiment, the calculating the offset distance further comprises calculating the offset distance in a direction of an apparent horizon line.

In another embodiment, the adjusting the disparity level of the identification element further comprises selecting a position at which the identification element is to be overlaid for identifying the object in one of the captured images and then selecting in the other of the captured images another position at which the identification element is to be overlaid based upon the disparity level of the object.

In one embodiment, the identification element is a three-dimensional element and the method further comprises rendering the three-dimensional element with two virtual cameras under a three-dimensional virtual scene based upon the calculated disparity level before it is overlaid on the images and the distance between the two virtual cameras is adjusted based upon the distance between two real cameras that capture the images of the object.

Another embodiment of the present invention provides an apparatus. The apparatus comprises means for capturing images of an object for a three-dimensional stereo display. The apparatus also comprises means for calculating a disparity level of the object by comparing the captured images. Further, the apparatus comprises means for adjusting a disparity level of an identification element to be the same as that of the object. In addition, the apparatus comprises means for displaying the identification element along with the object in a same depth in the three-dimensional stereo display.

An additional embodiment of the present invention provides an apparatus. The apparatus comprises at least one processor, and at least one memory including computer program code, the at least one memory and the computer program code configured to, with the at least one processor, cause the apparatus to at least perform capturing images of an object for a three-dimensional stereo display; calculating a disparity level of the object by comparing the captured images; adjusting a disparity level of an identification element to be the same as that of the object; and displaying the identification element along with the object in a same depth in the three-dimensional stereo display.

One embodiment of the present invention provides a computer program product. The computer program product comprises at least one computer readable storage medium having a computer readable program code portion stored thereon. The computer readable program code portion comprises program code instructions for capturing images of an object for a three-dimensional stereo display. The computer readable program code portion further comprises program code instructions for calculating a disparity level of the object by comparing the captured images. The computer readable program code portion also comprises program code instructions for adjusting a disparity level of an identification element to be the same as that of the object. In addition, the computer readable program code portion comprises program code instructions for displaying the identification element along with the object in a same depth in the three-dimensional stereo display.

With certain embodiments of the present invention, the positions of the identification elements may be adjusted or changed automatically such that they may be displayed or presented in a same depth as the respective objects they are identifying. Due to being in the same depth of the display, the 3D image displayed in this manner are more natural, vivid and clear and the objects in such a 3D image are more easily to be identified. Thereby, a viewer would enjoy a better user experience in the 3D stereo display.

Other features and advantages of the embodiments of the present invention would also be understood from the following description of specific embodiments when read in conjunction with the accompanying drawings, which illustrate, by way of example, the principles of embodiments of the invention.

### BRIEF DESCRIPTION OF THE DRAWINGS

The embodiments of the invention are presented in the sense of examples and their advantages are explained in greater detail below with reference to the accompanying drawings, in which:

FIG. 1 illustrates a situation in which a problem may arise when a plurality of objects need to be displayed along with their respective identification elements in the 3D stereo display;

FIG. 2 is a simplified flow chart illustrating a method according to an embodiment of the present invention;

FIG. 3 is a detailed flow chart illustrating a method according to an embodiment of the present invention;

FIG. 4 schematically illustrates how to calculate the offset distances according to an embodiment of the present invention;

FIGS. 5 further schematically illustrates how to calculate the offset distances according to an embodiment of the present invention; and

FIG. 6 is a block diagram illustrating an apparatus according to an embodiment of the present invention.

### DETAILED DESCRIPTION OF EMBODIMENTS

Embodiments of the present invention will be described in detail as below.

In one embodiment of the present invention, images of an object for a three-dimensional display are captured by an image capturing device, such as a portable imaging device, a mobile station, a personal digital assistance (PDA) or the like, which has two cameras, or more cameras where necessary, and is adapted to capture and then presents photos in a 3D stereo display. In both captured images, one would be the image viewed by the left eye of the human being and the other viewed by the right eye. Then, a disparity level of the object is calculated by comparing the captured images. The disparity level indicates a differential degree of the object in the two images. Typically, the differential degree may be denoted by an offset distance of the object in the two images.

To align an identification element with the object appropriately in a 3D stereo display, a disparity level of an identification element is adjusted to be the same as that of the object. Finally, the identification element is presented or displayed along with the object in a same depth in the 3D stereo display. In one embodiment, the disparity level of the object is calculated based upon the offset distance between one or more corresponding reference points on an outline of the object in the two captured images. The reference points are those points which are relatively much shorter to the cameras than other points. In another embodiment, the offset distance is calculated in a direction of an apparent horizon line.

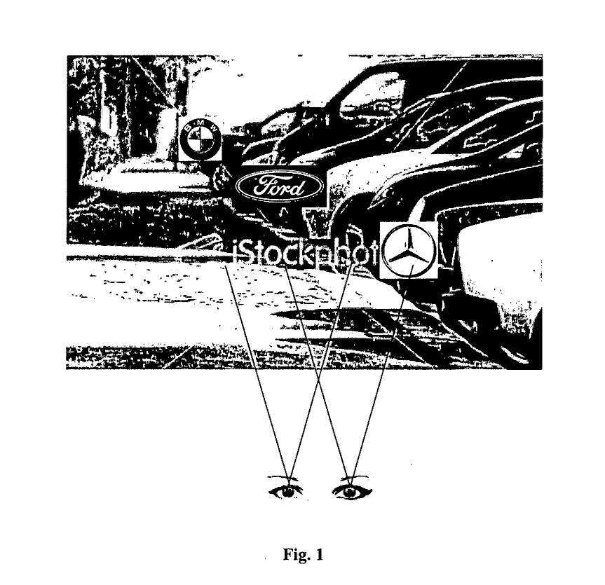

FIG. 1 has been described previously. It illustrates a situation in which a problem may arise when a plurality of objects need to be displayed along with their respective identification elements in the 3D stereo display.

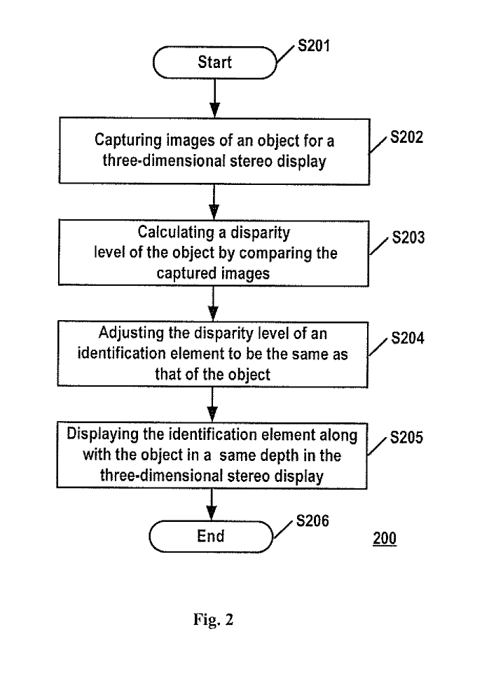

FIG. 2 is a simplified flow chart illustrating a method 200 according to an embodiment of the present invention. As illustrated in FIG. 2, the method starts at step S201 and then proceeds to step S202 where images of an object for a three-dimensional stereo display are captured. As is known to a person skilled in the art and also mentioned previously, one image would be for a view of the right eye and the other for a view of the left eye. Subsequent to capturing the images, the method proceeds to step S203. At step S203, the method 200 calculates a disparity level of the object by comparing the captured images. As previously described, the disparity level may be indicated by an offset distance of the same object in the two images.

Then, the method 200 adjusts at step S204 a disparity level of an identification element to be the same as that of the object. After adjusting the disparity level of the identification element, the method 200 displays, at step S205, the identification element along with the object in a same depth in the 3D display. More particularly, two same identification elements would be added to the two images captured by the image capturing device with regard to the same object, respectively, and then displayed with the same depth as the object in the 3D stereo display. Finally, the method 200 ends at step S206.

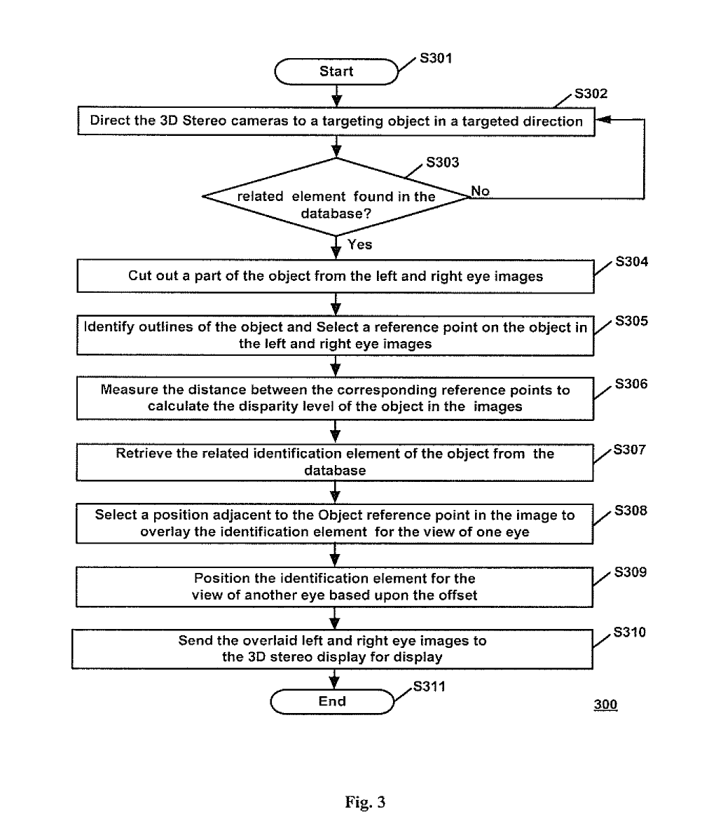

FIG. 3 is a detailed flow chart illustrating a method 300 according to an embodiment of the present invention. As illustrated in FIG. 3, the method 300 starts at step S301 and then proceeds to step S302 where two 3D stereo cameras separated by a certain distance are directed to capture a targeting object in a targeted direction. As above noted, two images, referred to as “the left eye image” and “the right eye image” hereinafter respectively, including the targeting object are formed upon the capture in question.

Then, at step S303, the method 300 checks a database to determine whether an identification element associating with the captured object exists therein so as to be added to the object. In some situation, step S303 may be optional and thus be omitted, e.g., in a case where the identification elements in the database are known to the user and thus the user only captures objects associating with such identification elements.

If it is determined that a corresponding or related identification element exists in the database, then the method 300 proceeds to step S304. At step S304, the method 300 cuts out a same part of the object from the above left and right eye images, respectively. Then, the method 300 proceeds to step S305 where the method 300 identifies or determines the outlines of the object in each of the left and right eye images by some graphic processing. Next, at step S306, the method 300 measures an offset distance between one or more corresponding reference points on the two outlines so as to calculate a disparity level of the captured object in the 3D stereo display.

On the one hand, in the case of one reference point being used, the disparity level of the captured object may be calculated directly by measuring the offset distance between the reference points in the two images. On the other hand, because different reference points on the outlines may have different disparity levels, the offset distances between each of the respective reference points in the two images may be calculated. The whole of the resulting offset distances, which may be given a variety of weights when necessary (e.g., the longer the offset distance is, the bigger the weight would be), may be considered as the disparity levels of the object with regard to the different reference points. In addition, where necessary, the resulting offset distances may be averaged. This averaged offset distance would be treated as the disparity level of the object.

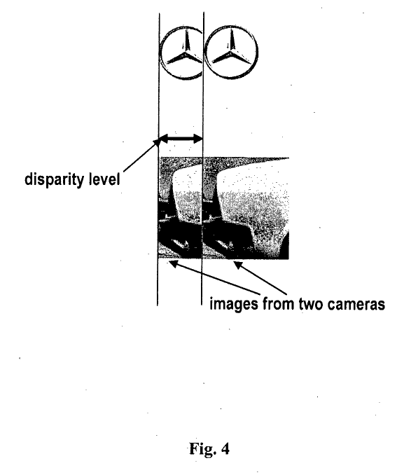

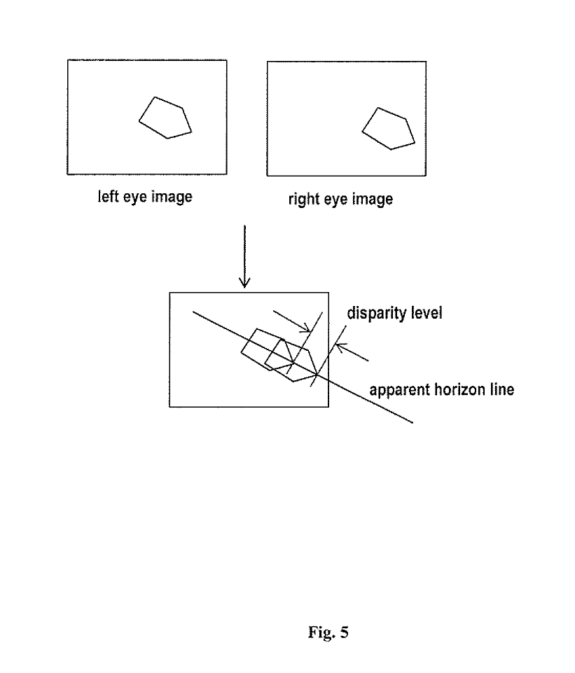

For better understanding of the present invention, FIGS. 4 and 5 schematically illustrate how to calculate the offset distance. As illustrated in the underpart of FIG. 4, the left and right eye images including a trail of a same Benz car are separated by an interval, i.e., the offset distance of the present invention, which may be obtained by measuring the distance between the corresponding reference points (not shown) in the two images. Further, in FIG. 5, the disparity level is calculated in a direction of an apparent horizon line. The direction of the apparent horizon line may be determined by the steps as below.

First, by means of similar steps as steps S304 and S305, the outlines of the object in the two images are formed. Then, by analyzing the outlines, some reference points may be sampled. Next, the direction of the apparent horizon line may be determined by linking such reference points and observing the change thereof. Finally, the offset distance between the corresponding reference points in both images may be determined or measured in the direction of the apparent horizon line.

For example, as illustrated in the upper part of FIG. 5, a pentagonal object is shown in both left and right eye images. Although not shown, it should be understood that some points (e.g., five endpoints) may be sampled from the pentagonal object and then the disparity level of the object may be determined by linking these points and measuring the offset distance of these points in the apparent horizon line direction, as illustrated in the underpart of FIG. 5.

Returning back to FIG. 3, subsequent to measuring the offset distance, the method 300 proceeds to step S307 where an identification element, such as a logo (as shown in FIG. 4), an icon, a text message, or a graphic element which serves as identifying the object, would be retrieved from the database. Then the method 300 proceeds to step S308. At step S308, the method 300 selects in one of the images, such as the left eye image, a position where is adjacent to the object and, preferably, good for identifying the object to the extent that it appears to be attached onto the object in the left eye image. In other words, the identification element would be overlaid at this position for the view of the left eye.

Further, the method 300 proceeds to step S309 where it determines, based upon the calculated offset distance, another position of the identification element in another one of the images, such as the right eye image, that is, moving the identification element by the distance equal to the offset distance, which is the same as illustrated in the upper part of FIG. 4. In other words, the method 300 selects a position at which the identification element is to be overlaid for identifying the object in one of the captured images (e.g., the left eye image) and then selecting in the other of the captured images (e.g., the right eye image) another position at which the identification element is to be overlaid based upon the disparity level.

By carrying out steps S308 and S309, it is sufficient for a 2D identification element to be overlaid appropriately and precisely on the two images. However, with a 3D identification element, alternatively or preferably, the method 300 at step S309 sets up two virtual cameras (e.g., implemented by computer instructions according to the two real cameras) and then renders the 3D identification element in each image under a 3D virtual scene based upon the calculated disparity level before it is overlaid on the images. The distance between the two virtual cameras is adjusted based upon the distance between two real cameras that capture the images of the object. By such a rendering operation, the disparity levels of a certain amount of points on the 3D identification element would be the same as those corresponding reference points on the outline of the object.

It would be understood to those skilled in the art that the above rendering operation may be implemented by some prior methods or algorithms and thus omitted herein to avoid unnecessarily obscuring the present invention.

Then, the method 300 proceeds to step S310, where it sends the left and right eye images overlaid with the adjusted identification elements to the 3D stereo display. Finally, the method 300 ends at step S311. If at step S303, it is failed to find an identification element associating with the captured object, then the method 300 returns to step S302 and takes next round of processing. Because the method 300 takes into account the offset distance of the object in the two images, the identification element overlaid on the images appears to be more vivid or natural in the final 3D stereo image.

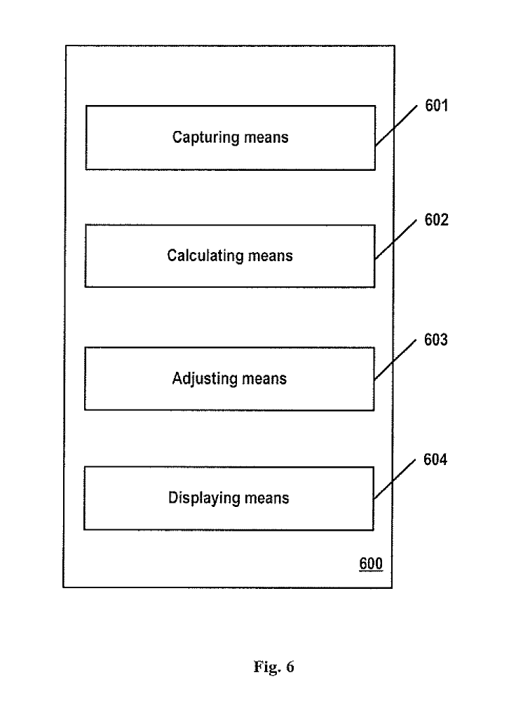

FIG. 6 is a block diagram illustrating an apparatus 600 according to an embodiment of the present invention. As illustrated in FIG. 6, the apparatus 600 includes a capturing means 601, a calculating means 602, an adjusting means 603, and a displaying means. The capturing means 601 is for capturing images of an object for a three-dimensional stereo display. The calculating means 602 is for calculating a disparity level of the object by comparing the captured images. The adjusting means 603 is for adjusting a disparity level of an identification element to be the same as that of the object. The displaying means 604 is for displaying the identification element along with the object in a same depth in the three-dimensional stereo display. It can be seen that the apparatus 600 may carry out any steps as described in methods 200 and 300. Further, the apparatus 600 may be embodied in a 3D-enabled mobile station.

Exemplary embodiments of the present invention have been described above with reference to block diagrams and flowchart illustrations of methods and apparatuses (i.e., systems). It should be understood that each block of the block diagrams and flowchart illustrations, and combinations of blocks in the block diagrams and flowchart illustrations, respectively, can be implemented in various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-20. (canceled)

21. A method, comprising:
capturing images of an object for a three-dimensional stereo display;
calculating a disparity level of the object by comparing the captured images;
adjusting a disparity level of an identification element to be the same as that of the object; and
displaying the identification element along with the object in a same depth in the three-dimensional stereo display.

22. A method as recited in claim 21, further comprising using an image capturing device which is incorporated into a mobile device and has two or more cameras to capture images for the three-dimensional stereo display.

23. A method as recited in claim 21, wherein the calculating the disparity level of the object further comprises calculating an offset distance between one or more corresponding reference points on an outline of the object in the two captured images.

24. A method as recited in claim 23, wherein the reference points have much shorter distance to an image capturing device which has captured the images than other points on the outline of the object.

25. A method as recited in claim 23, wherein the calculating the disparity level of the object further comprises calculating offset distances between each of the reference points and then averaging the calculated offset distances.

26. A method as recited in claim 23, wherein the calculating the disparity level of the object further comprises calculating offset distances between each of the reference points and then giving the reference points different weights to obtain respective disparity level of each reference point.

27. A method as recited in claim 23, wherein the calculating the offset distance further comprises calculating the offset distance in a direction of an apparent horizon line.

28. A method as recited in claim 21, wherein the adjusting the disparity level of the identification element further comprises selecting a position at which the identification element is to be overlaid for identifying the object in one of the captured images and then selecting in the other of the captured images another position at which the identification element is to be overlaid based upon the disparity level of the object.

29. A method as recited in claim 28, wherein the identification element is a three-dimensional element and the method further comprises rendering the three-dimensional element with two virtual cameras under a three-dimensional virtual scene based upon the calculated disparity level before it is overlaid on the images and the distance between the two virtual cameras is adjusted based upon the distance between two real cameras that capture the images of the object.

30. An apparatus, comprising:
at least one processor, and at least one memory including compute program code, the at least one memory and the computer program code configured to, with the at least one processor, cause the apparatus to at least perform:
capturing images of an object for a three-dimensional stereo display;
calculating a disparity level of the object by comparing the captured images;
adjusting a disparity level of an identification element to be the same as that of the object; and
displaying the identification element along with the object in a same depth in the three-dimensional stereo display.

31. A computer program product, comprising at least one computer readable storage medium having a computer readable program code portion stored thereon, the computer readable program code portion comprising:
program code instructions for capturing images of an object for a three-dimensional stereo display;
program code instructions for calculating a disparity level of the object by comparing the captured images;
program code instructions for adjusting a disparity level of an identification element to be the same as that of the object; and
program code instructions for displaying the identification element along with the object in a same depth in the three-dimensional stereo display.

32. An apparatus as recited in claim 30, wherein the apparatus is further caused to use an image capturing device which is incorporated into a mobile device and has two or more cameras to capture images for the three-dimensional stereo display.

33. An apparatus as recited in claim 30, wherein the apparatus is caused to calculate the disparity level of the object by at least in part by calculating an offset distance between one or more corresponding reference points on an outline of the object in the two captured images.

34. An apparatus as recited in claim 33, wherein the reference points have much shorter distance to an image capturing device which has captured the images than other points on the outline of the object.

35. An apparatus as recited in claim 33, wherein the apparatus is caused to calculate the disparity level of the object by at least in part by calculating offset distances between each of the reference points and then averaging the calculated offset distances.

36. An apparatus as recited in claim 33, wherein the apparatus is caused to calculate the disparity level of the object at least in part by calculating offset distances between each of the reference points and then giving the reference points different weights to obtain respective disparity level of each reference point.

37. An apparatus as recited in claim 33, wherein the apparatus is caused to calculate the offset distance at least in part by calculating the offset distance in a direction of an apparent horizon line.

38. An apparatus as recited in claim 30, wherein the apparatus is caused to adjust the disparity level of the identification element at least in part by selecting a position at which the identification element is to be overlaid for identifying the object in one of the captured images and then selecting in the other of the captured images another position at which the identification element is to be overlaid based upon the disparity level of the object.

39. An apparatus as recited in claim 38, wherein the identification element is a three-dimensional element and the method further comprises rendering the three-dimensional element with two virtual cameras under a three-dimensional virtual scene based upon the calculated disparity level before it is overlaid on the images and the distance between the two virtual cameras is adjusted based upon the distance between two real cameras that capture the images of the object
